(19) United States
(12) Patent Application Publication
(10) Pub. No.: US 2014/0188299 A1
(43) Pub. Date: Jul. 3, 2014

(54) DISPLAY DEVICE, DISPLAY METHOD, AND PROGRAM PRODUCT

(71) Applicant: Kabushiki Kaisha Toshiba, Tokyo (JP)

(72) Inventor: Satoshi Odakura, Tokyo (JP)

(73) Assignee: Kabushiki Kaisha Toshiba, Tokyo (JP)

(21) Appl. No.: 14/010,886

(22) Filed: Aug. 27, 2013

Related U.S. Application Data
(63) Continuation of application No. PCT/JP2013/058427, filed on Mar. 22, 2013.

(30) Foreign Application Priority Data
Dec. 28, 2012 (JP) 2012-288878

(51) Int. Cl. G05B 15/02

(52) U.S. Cl. CPC G05B 15/02
USPC 700/297

(57) ABSTRACT

According to one embodiment, a display device includes: a setting module configured to set a first ECO mode and a second ECO mode different from the first ECO mode to an electric appliance which is a managed object of HEMS (Home Energy Management System), each of the first and second ECO modes being for reducing an amount of power consumption; and a display configured to display an icon corresponding to the electric appliance differently between the set first ECO mode and the set second ECO mode.

### CROSS-REFERENCE TO RELATED APPLICATIONS

This application is a continuation of International Application No. PCT/JP2013/058427, filed on Mar. 22, 2013 which claims the benefit of priority of the prior Japanese Patent Application No. 2012-288878, filed on Dec. 28, 2012, the entire contents of which are incorporated herein by reference.

### FIELD

Embodiments described herein relate generally to a display device, a display method, and a program product.

### BACKGROUND

In the related art, HEMS (Home Energy Management System) has been known as an energy management system of a plurality of electric appliances in power consumers such as homes or shops. In the HEMS, an energy saving, a cost saving, or a reduction of CO₂ emission is performed by a display of operational states or used (consumed) energy (amount of power consumption) of the plurality of electric appliances on a display device such as a power information terminal provided in a kitchen, a living room, or the like or by a control under an ECO mode.

In a display device of the related art, however, a display of an ECO mode is merely carried out, thus causing a user not to easily identify that a setting state for an energy saving, a cost saving, or a reduction of CO2 emission is set for certain reasons. For example, the user could not easily recognize that a control is performed under an ECO mode by a user setting or is performed under an ECO mode by a CEMS (Cluster/Community Energy Management System) or a request of electric power suppliers.

### BRIEF DESCRIPTION OF THE DRAWINGS

A general architecture that implements the various features of the invention will now be described with reference to the drawings. The drawings and the associated descriptions are provided to illustrate embodiments of the invention and not to limit the scope of the invention.

FIG. 1 is an exemplary schematic view illustrating an example of HEMS according to an embodiment;

FIG. 2 is an exemplary block diagram illustrating a functional configuration of a power information terminal according to the embodiment;

FIG. 3 is an exemplary flowchart illustrating an example of an operation of the power information terminal according to the embodiment;

FIG. 4 is an exemplary conceptual diagram illustrating an example of a screen of the power information terminal according to the embodiment;

FIG. 5 is an exemplary conceptual diagram illustrating an example of a screen of the power information terminal according to the embodiment;

FIG. 6 is an exemplary conceptual diagram illustrating an example of a screen of the power information terminal according to the embodiment;

FIG. 7 is an exemplary conceptual diagram illustrating an example of a screen of the power information terminal according to the embodiment;

FIG. 8 is an exemplary conceptual diagram illustrating an example of a screen of the power information terminal according to the embodiment;

FIG. 9 is an exemplary conceptual diagram illustrating an example of a screen of the power information terminal according to the embodiment; and

FIG. 10 is an exemplary conceptual diagram illustrating an example of a setting screen of the power information terminal according to the embodiment.

### DETAILED DESCRIPTION

In general, according to one embodiment, a display device comprises: a setting module configured to set a first ECO mode and a second ECO mode different from the first ECO mode to an electric appliance which is a managed object of HEMS (Home Energy Management System), each of the first and second ECO modes being for reducing an amount of power consumption; and a display configured to display an icon corresponding to the electric appliance differently between the set first ECO mode and the set second ECO mode.

Hereinafter, a display device, a display method, and a program according to an embodiment will be described in detail with reference to accompanying drawings. Further, as an example, the present embodiment describes a power information terminal which is a display device of HEMS (Home Energy Management System) acting as an energy management system of a plurality of electric appliances in power consumers such as homes or shops, and which displays an operational state or a used (consumed) energy (amount of power consumption) of the plurality of electric appliances or performs an energy saving, a cost saving, or a reduction of CO₂ emission (hereinafter, simply referred to as an energy saving) by a control under an ECO mode.

Further, the power information terminal may be a dedicated information terminal provided in a kitchen or a living room and may commonly be used with a television receiver or a monitor installed at a front of a refrigerator. For example, in a case of being commonly used with the television receiver or the monitor of the refrigerator, the power information terminal may be implemented by reading out and executing a predetermined program through a pressing operation of “HEMS button”.

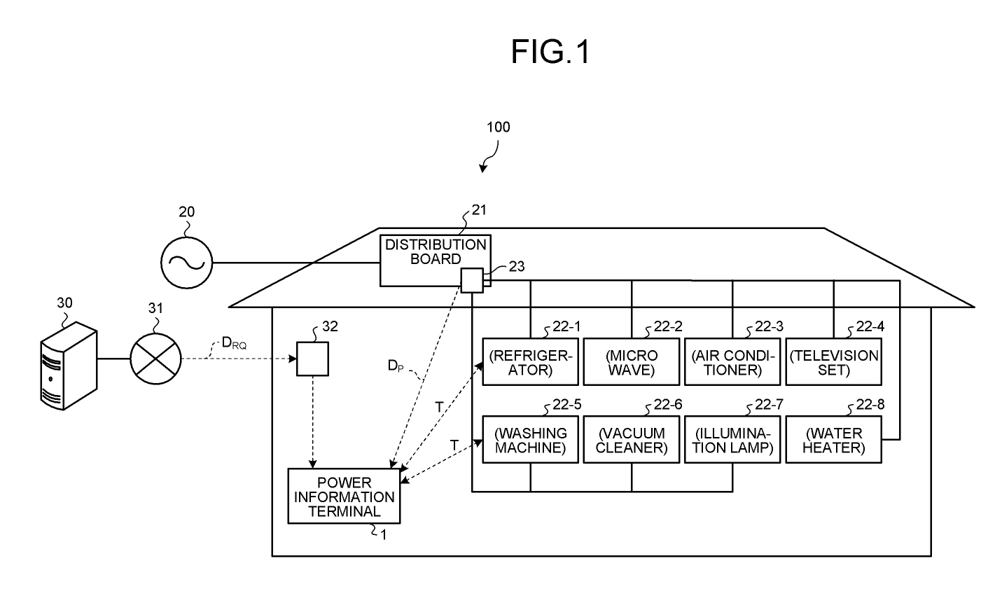

FIG. 1 is a schematic view illustrating an example of HEMS 100 according to the embodiment. As illustrated in FIG. 1, the HEMS 100 manages power which is supplied by a commercial system 20, and is distributed into in-home electric appliances 22-1 to 22-8 through a distribution board 21, by a power information terminal 1 provided in the kitchen, the living room, or the like.

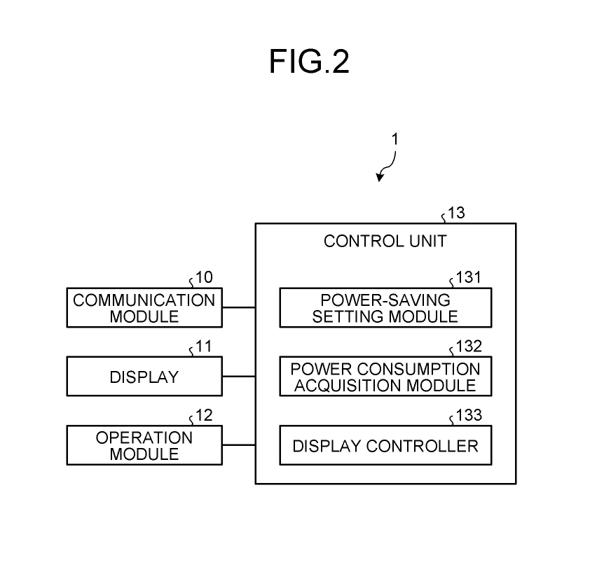

The power information terminal 1 is a terminal device including a display 11 such as a LCD (Liquid Crystal Display) and an operation module 12 such as an operation key or touch panels layered on the display 11 (see FIG. 2 for both components). The power information terminal 1 communicates with a server 30 of CEMS (Cluster/Community Energy Management System) through a home gateway 32 and a communication network 31, and performs a communication T with the in-home electric appliances 22-1 to 22-8 to be managed and a power measurement device 23 of the distribution board 21 through an ECHONET Lite (ECHONET Lite, registered trademark), thereby performing confirmation of power information or a control of the electric appliances 22-1 to 22-8 in the HEMS 100. Here, the ECHONET Lite is a HEMS standard communication protocol which objectifies an air conditioner, an illumination lamp, a water heater, a smart meter, various sensors, or the like to perform an operation and a state acquisition of each appliance according to access rules referred to as GET (state acquisition), SET (setting), ANNOUNCE (announcement), or the like.

The server 30 manages the CEMS, that is, manages the power consumption of an entire region including the HEMS through the communication network 31 such as an Internet. Specifically, the server 30 announces a demand response D_{RQ}, which is an adjustment (reduction) request of the amount of power consumption, to each HEMS 100 through the communication network 31. The home gateway 32 is provided within the home of each HEMS 100, and the demand response D_{RQ} through the communication network 31 is announced to the power information terminal 1 via the home gateway 32.

As a power demand increases compared to a supply power, when the supply capacity from a power provider is tight for the amount of power consumption or when a charge for the amount of power consumption is relatively expensive, the demand response D_{RQ} is announced from the server 30. In addition, the demand response D_{RQ} contains a level of reduction request of the amount of power consumption, time zone (for example, time zone in which the charge is relatively expensive) corresponding to the reduction request, and information such as a reducing amount of power or reduction rate.

The power measurement device 23 is provided in the distribution board 21 to measure a main amount of power which is supplied from the commercial system 20 and an amount of power for each system which distributes the main amount of power into the electric appliances 22-1 to 22-8. The power measurement device 23 performs the communication with the power information terminal 1 using a predetermined communication standard such as the ECHONET Lite to announce a measured amount of power Dp to the power information terminal 1.

The electric appliances 22-1 to 22-8 are various electric appliances installed within the home of the HEMS 100. Specifically, the electric appliances may be a refrigerator, a micro wave, an air conditioner, a television set, a washing machine, a vacuum cleaner, an illumination lamp, a water heater, or the like. The electric appliances 22-1 to 22-8 performs the communication with the power information terminal 1 using the predetermined communication standard such as the ECHONET Lite to announce the amount of power used (consumed) in each of the appliances to the power information terminal 1 or to perform a power-saving control in response to the reduction request of the amount of power consumption from the power information terminal 1.

FIG. 2 is a block diagram illustrating a functional configuration of the power information terminal 1 according to the embodiment. As illustrated in FIG. 2, the power information terminal 1 includes a communication module 10, a display 11, an operation module 12, and a controller 13.

Under the control of the controller 13, the communication module 10 performs the communication with the server 30 through the home gateway 32 and the communication network 31, and performs the communication with the power measurement device 23 and the electric appliances 22-1 to 22-8 through the ECHONET Lite.

The controller 13 includes CPU (Central Processing Unit), ROM (Read Only Memory), and RAM (Random Access Memory) (all of these components are not illustrated in drawings) and controls the operation of the power information terminal 1 in such a manner as the CPU expands a program which is stored in ROM to the RAM and sequentially executes the program. Specifically, the CPU executes the program, and thus the controller 13 implements functions as a power-saving setting module 131, a power-consumption acquisition module 132, and a display controller 133.

The power-saving setting module 131 sets ON/OFF of a power-saving mode (ECO mode) for the purpose of reducing the amount of power consumption for each of the electric appliances 22-1 to 22-8 to be managed by the power information terminal 1, based on a user operation through the operation module 12 or the demand response D_{RQ} which is announced from the server 30 through the communication module 10. Further, shift instruction to the ECO mode is transmitted to the electric appliances to which the ECO mode is set. Further, even in a case of transmitting the shift instruction based on the user operation and even in a case of transmitting the shift instruction based on the demand response D_{RQ}, the shift to the same state may be instructed to the electric appliances. In a case of receiving the shift instruction to the ECO mode derived from the user operation and in a case of receiving the shift instruction to the ECO mode derived from the demand response D_{RQ}, that is, the electric appliances may execute the same process and be shifted to the same power state. Setting information of these ECO modes is managed in a predetermined area reserved on the RAM or a rewritable area of the ROM. In the electric appliances 22-1 to 22-8, the power-saving control is performed with reference to the above setting information.

The ECO mode in the power-saving setting module 131 includes two ECO modes (first ECO mode and second ECO mode), for example, the ECO mode (ECO mode of user setting) based on the operation of the user through the operation module 12 and the ECO mode (ECO mode of DR setting) based on the demand response D_{RQ}. The ON/OFF setting of these two ECO modes is managed by separate setting information. Further, the ECO mode of the user setting will be performed by the selection of each of the electric appliances 22-1 to 22-8, and the ECO mode of the DR setting will collectively be performed in the electric appliances 22-1 to 22-8 based on the presence or absence of the demand response.

The power-consumption acquisition module 132 acquires a total amount of power consumption of the HEMS 100 and an individual amount of power consumption of the electric appliances 22-1 to 22-8 based on the announcement from the power measurement device 23 and the electric appliances 22-1 to 22-8 by the predetermined communication standard such as the ECHONET Lite. Further, with respect to the electric appliances not corresponding to the communication standard such as the ECHONET Lite among the electric appliances 22-1 to 22-8, it is assumed to obtain the amount of power consumption as “other appliances” which subtracts the individual amount of power consumption of the electric appliances corresponding to the communication standard such as the ECHONET Lite from the total amount of power consumption in the power measurement device 23.

The display controller 133 performs a display control of a screen in the display 11. Specifically, the display controller 133 controls a display of the ON/OFF of the ECO mode set by the power-saving setting module 131 onto the display 11 and a display of the total amount of power consumption of the HEMS 100 and the individual amount of power consumption of the electric appliances 22-1 to 22-8 acquired by the power-consumption acquisition module 132 onto the display 11. Furthermore, the ECO mode of the user setting and the ECO mode of the DR setting, which are separately set by the power-saving setting module 131, are separately displayed on the display 11 (details will be described later).

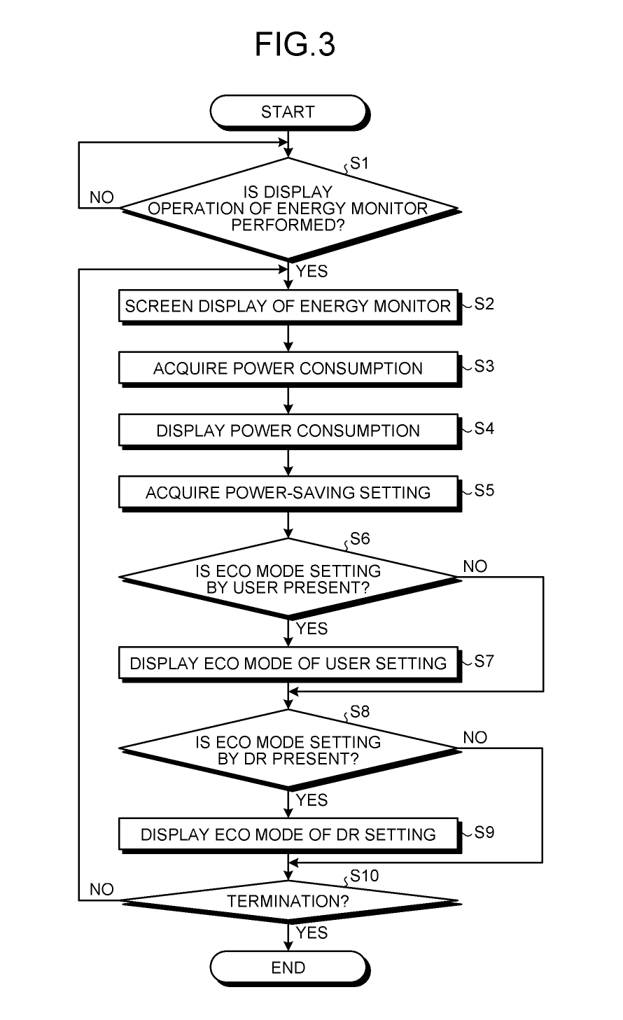

Next, an operation of the power information terminal 1 which is performed under the control of the controller 13 will be described. FIG. 3 is a flowchart illustrating an example of the operation of the power information terminal 1 according to the embodiment.

As illustrated in FIG. 3, when a process is started by power activation or the like, the display controller 133 of the controller 13 determines whether or not a display operation of an energy monitor for displaying various types of information such as the amount of power consumption of the HEMS 100 is performed by the operation module 12 (S1).

Here, when the display operation of the energy monitor is not performed (NO in S1), the process is waiting. When the display operation of the energy monitor is performed (YES in S1), the display controller 133 performs the screen display of the energy monitor on the display 11 (S2).

Then, the power-consumption acquisition module 132 acquires the entire power consumption of the HEMS 100 and the individual amount of power consumption of the electric appliances 22-1 to 22-8 based on the communication T by the predetermined communication standard such as the ECHONET Lite (S3).

Next, the display controller 133 displays the total amount of power consumption of the HEMS 100 and the individual amount of power consumption of the electric appliances 22-1 to 22-8, which are acquired by the power-consumption acquisition module 132, on the screen of the energy monitor (S4).

Then, the display controller 133 reads out the setting information which is set by the power-saving setting module 131 to acquire the power-saving setting in the HEMS 100 (S5) and to determine whether or not the ECO mode setting through the operation of the operation module 12 by the user is present, that is, the presence or absence of the ECO mode of the user setting (S6).

When the ECO mode of the user setting is present (YES in S6), the display controller 133 displays the ECO mode of the user setting on the screen of the energy monitor (S7). Specifically, an icon indicating the ECO mode of the user setting is displayed on a predetermined area of the screen.

Next, the display controller 133 determines whether or not the setting of the ECO mode by a demand response DR from the server 30 is present, that is, the presence or absence of the ECO mode of the DR setting (S8).

When the ECO mode of the DR setting is present (YES in S8), the display controller 133 displays the ECO mode of the DR setting on the screen of the energy monitor (S9). Specifically, an icon indicating the ECO mode of the DR setting is displayed on an area of the screen different from the area on which the icon indicating the ECO mode of the user setting is displayed.

Then, the display controller 133 determines the presence or absence of the end of the process based on the presence or absence of the operation of the operation module 12 which makes the screen display of the energy monitor terminate (S10). When the process is continued (NO in S10), the process is returned to step S2 by the display controller 133. When the process is terminated (YES in S10), the display controller 133 terminates the screen display of the energy monitor in the display 11.

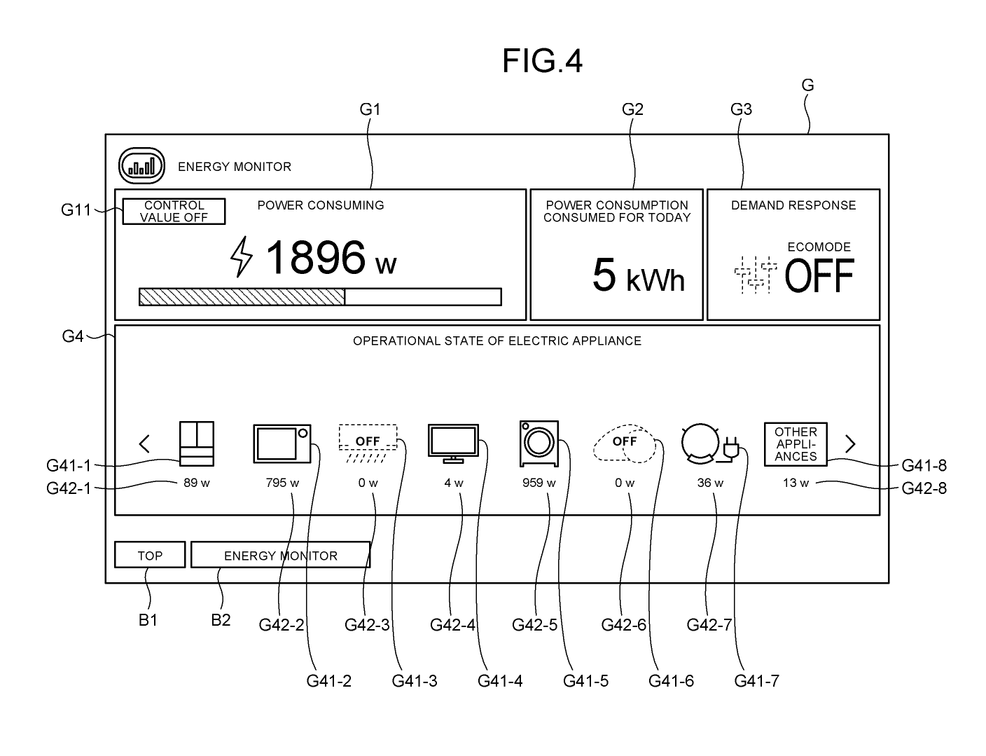

FIGS. 4 to 9 are conceptual diagrams illustrating examples of a screen G of the power information terminal 1 according to the embodiment, more specifically, are diagrams illustrating the screen G of the energy monitor. When the display operation of the energy monitor is performed, depending on the above-described process, the screen G illustrated in FIGS. 4 to 9 is displayed on the display 11.

An operation button B1 on the screen G is a button that allows instruction to return to a top screen by terminating the display of the energy monitor. An operation button B2 is a button that allows instruction to start the display of the energy monitor. The user can instruct the start/end of the display of the energy monitor by operating the operation buttons B1 and B2 through the operation module 12.

A power-consumption display G1 is the total amount of power consumption of the HEMS 100 acquired in S3. The power-consumption display G1 displays a current amount of power consumption on the screen G in graph form such as a bar graph. A power history display G2 is a history of the total amount of power consumption of the HEMS 100 acquired in S3 and displays a value obtained by integrating the amount of power consumption at a predetermined period (for example, for one day).

A control-value display button G11 in the power-consumption display G1 is a button that sets the presence or absence (ON/OFF) of the display of a limit value for limiting the amount of power consumption based on the ECO mode of the user setting or the ECO mode of the DR setting. The limit value is a preset value as a target value for limiting the amount of power consumption when the ECO mode of the user setting or the ECO mode of the DR setting is valid. The user switches the ON/OFF of the control-value display button G11 by the operation of the operation module 12 to select the presence or absence of the display of the limit value when the ECO mode of the user setting or the ECO mode of the DR setting is valid.

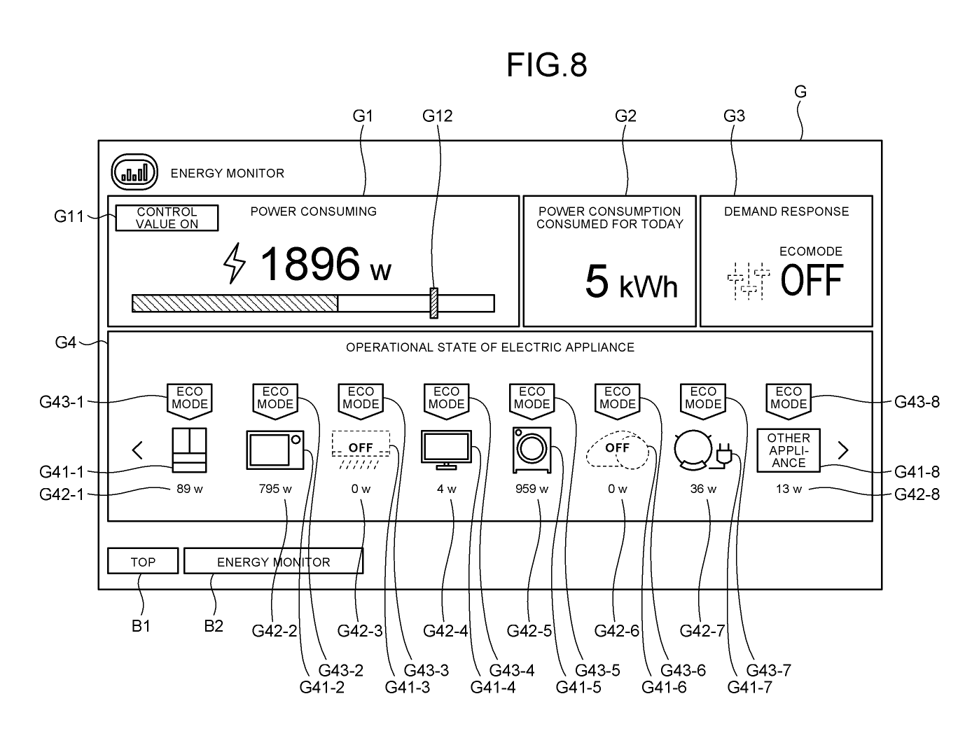

As illustrated in FIG. 8, when the control-value display button G11 is ON, the display controller 133 displays a control-value icon G12 corresponding to the limit value by the ECO mode on the graph (bar graph) of the power-consumption display G1, which indicates the amount of power consumption. In the illustrated example, since the ECO mode of the user setting is valid, the control-value icon G12 indicating the limit value corresponding to the ECO mode of the user setting is displayed on the bar graph of the power-consumption display G1. For this reason, the user can easily recognize the relationship between the current amount of power consumption and the limit value corresponding to the ECO mode.

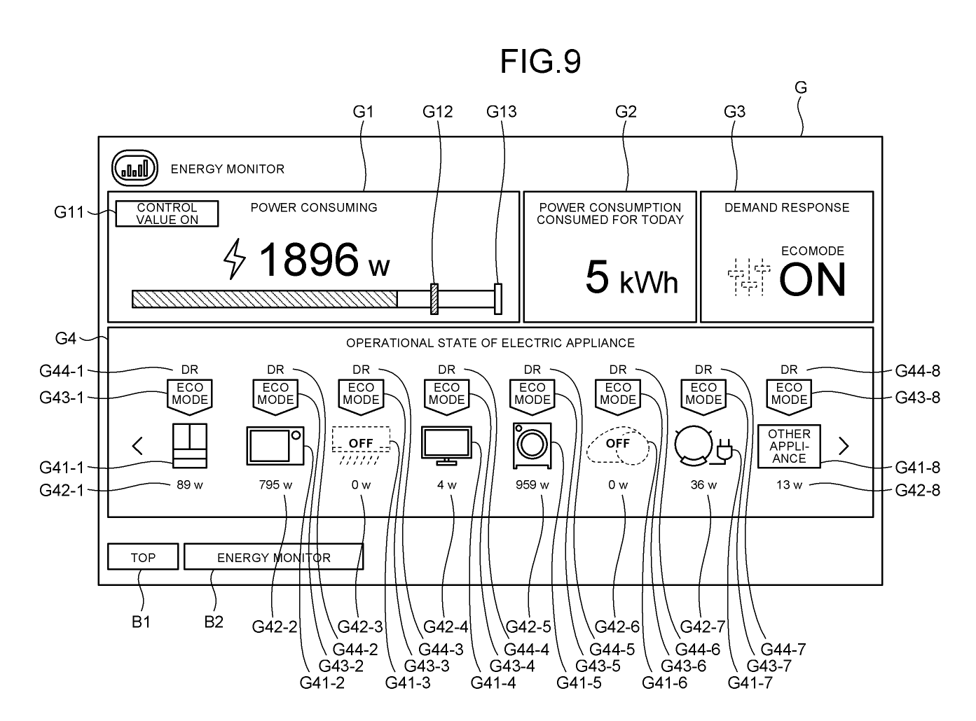

In addition, when the ECO mode of the user setting and the ECO mode of the DR setting are valid, the graph in which a larger control value of two control values based on these two ECO modes is an upper value is displayed on the power-consumption display G1. Specifically, as illustrated in FIG. 9, the display controller 133 displays the graph (bar graph) which indicates the amount of power consumption in which a lager control value of two control values based on two ECO modes is an upper value G13, on the power-consumption display G1. Thus, the user can easily recognize the relationship between the current amount of power consumption and two control values based on two ECO modes of the ECO mode of the user setting and the ECO mode of the DR setting.

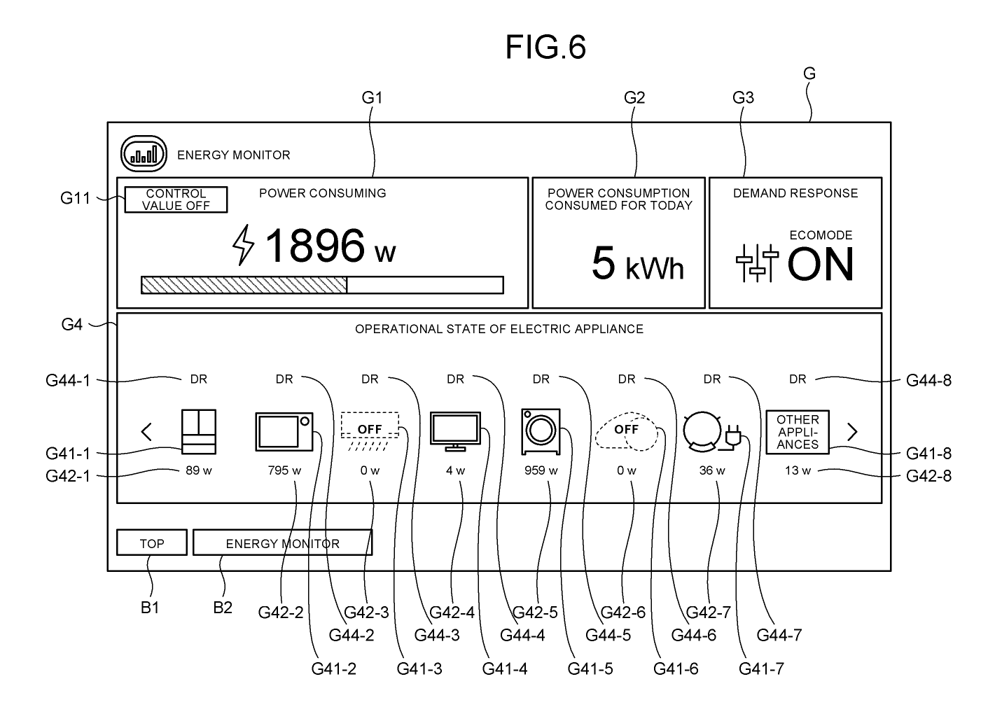

A demand response display G3 indicates the presence or absence (ON/OFF) of the demand response DR from the server 30. Specifically, as illustrated in FIGS. 4, 5, and 8, when the demand response DR from the server 30 is in an OFF state, the display of the OFF state is performed. In addition, as illustrated in FIGS. 6, 7, and 9, when the demand response DR from the server 30 is in an ON state, the display of the ON state is performed. For this reason, the user can recognize the presence or absence of the announcement of the demand response by the CEMS.

The electric appliance display G4 indicates a state (operational state of household electric appliance) of each of the electric appliances 22-1 to 22-8 based on the communication through the ECHONET Lite. Specifically, electric-appliance icons G41-1 to G41-8 for each of the electric appliances 22-1 to 22-8 and power displays G42-1 to G42-8 indicating the amount of power consumption are displayed by the display controller 133. Further, in the refrigerator, the micro wave, the air conditioner, the television set, the washing machine, the vacuum cleaner, the illumination lamp, or the like identified by the communication through the ECHONET Lite, the electric-appliance icons G41-1 to G41-7 and the power displays G42-1 to G42-7 corresponding to the identified appliances are displayed, and in “other appliances” not corresponding to the communication standard such as the ECHONET Lite, the electric-appliance icon G41-8 and the power displays G42-8 corresponding to other appliances are displayed.

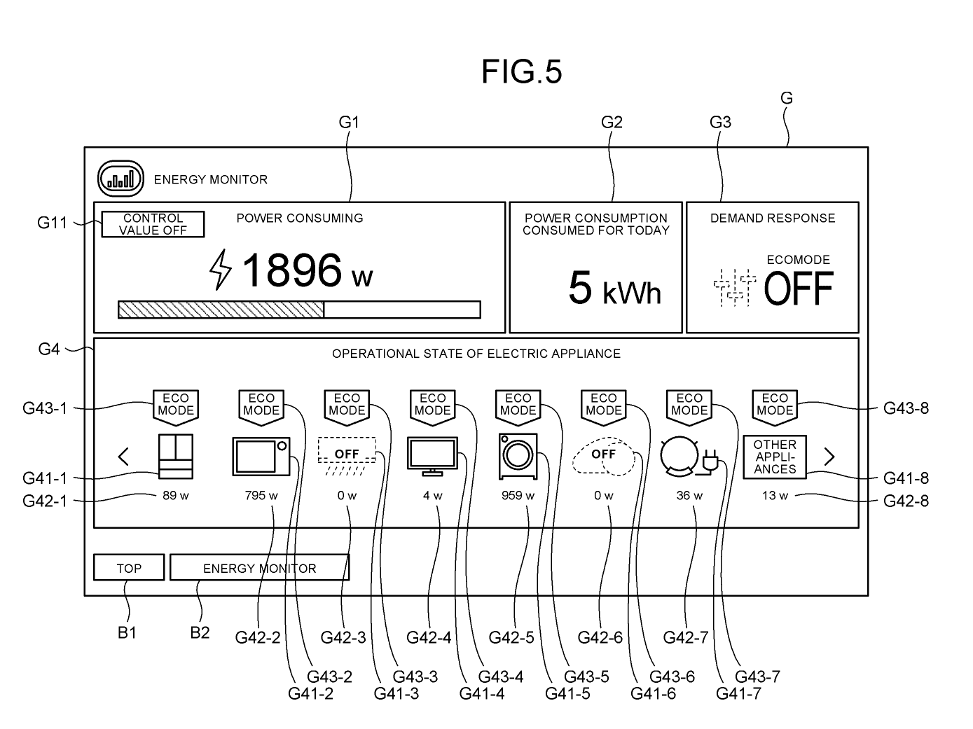

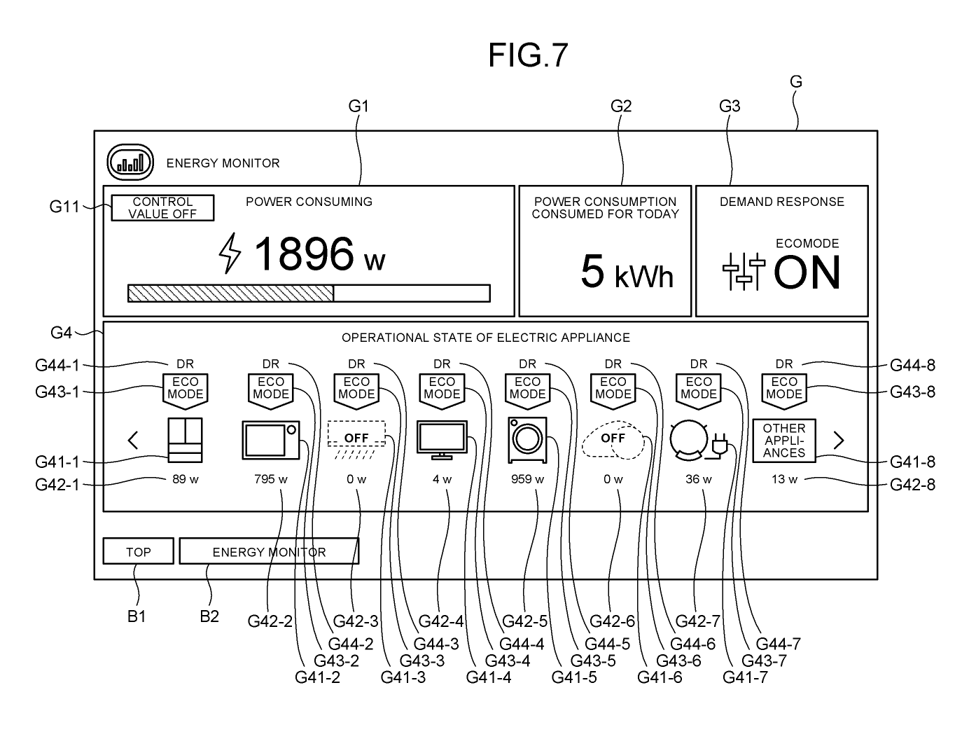

In addition, the display controller 133 displays icons based on the presence or absence of the ECO mode of the user setting on positions corresponding to the electric-appliance icons G41-1 to G41-8 for each of the electric appliances 22-1 to 22-8. Specifically, as illustrated in FIGS. 5, 7, to 9, ECO mode icons G43-1 to G43-8 indicating that the ECO mode of the user setting is valid are displayed.

In addition, the display controller 133 displays icons based on the presence or absence of the ECO mode of the DR setting on the positions corresponding to the electric-appliance icons G41-1 to G41-8 for each of the electric appliances 22-1 to 22-8. Specifically, as illustrated in FIGS. 6, 7, and 9, ECO mode icons G44-1 to G44-8 indicating that the ECO mode of the DR setting is valid are displayed.

As is apparent from the comparison of FIGS. 5 to 9, the ECO mode icons G43-1 to G43-8 indicating that the ECO mode of the user setting is valid and the ECO mode icons G44-1 to G44-8 indicating that the ECO mode of the DR setting is valid are distinguishably displayed at the positions different from each other. Specifically, the ECO mode icons G43-1 to G43-8 and the ECO mode icons G44-1 to G44-8 are arranged up and down on the electric-appliance icons G41-1 to G41-8 to more easily identify which ECO mode is valid or invalid. For this reason, the user can easily recognize the setting state for the energy saving (ECO mode of user setting and ECO mode of DR setting). That is, in the state where the ECO mode by the user setting is set for some appliances among the electric appliances 22-1 to 22-8, for example, when the ECO mode by the DR setting is set for all of the appliances, the ECO mode icons G43 and G44 are displayed for some of the appliances and the ECO mode icon G44 may be displayed without displaying the ECO mode icon G43 for other appliances. Thus, when the electric appliances 22-1 to 22-8 are in the ECO mode state, it is possible to easily recognize the appliances which are set to the ECO mode by the user setting and the appliances which are set to the ECO mode by the DR setting.

Further, in the screen G, a selection operation (for example, push and hold) of the electric-appliance icons G41-1 to G41-8 is allowed by the operation module 12. When the selection operation of the electric-appliance icons G41-1 to G41-8 is performed, the display controller 133 displays the setting screen for performing the setting of the selected electric-appliance icons G41-1 to G41-8 on the display 11.

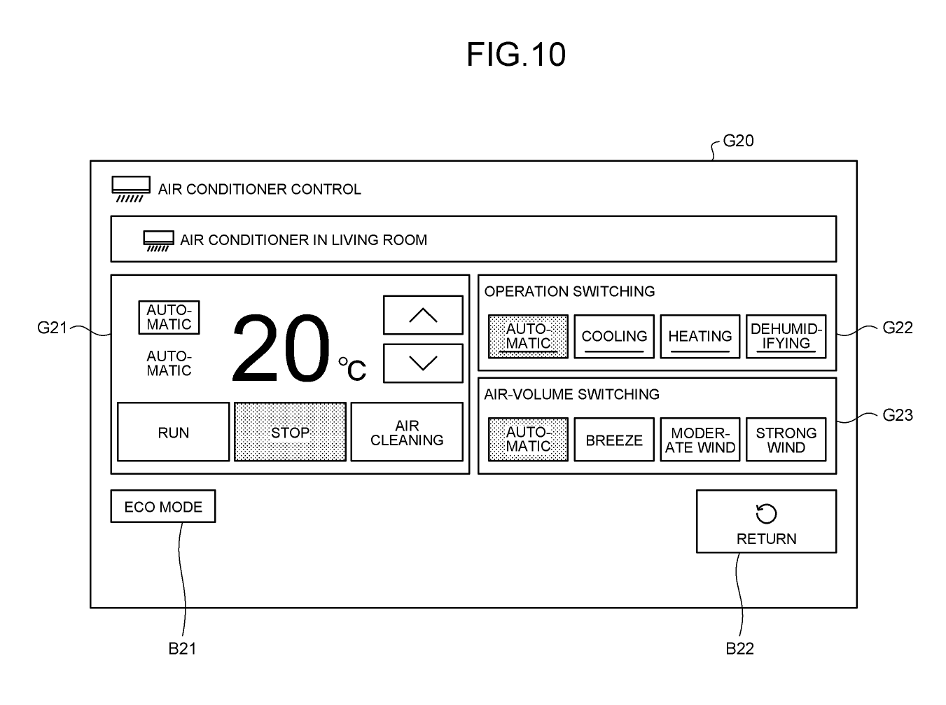

FIG. 10 is a conceptual diagram illustrating an example of a setting screen G20 of the power information terminal 1 according to the embodiment. As illustrated in FIG. 10, when the electric-appliance icon such as the air conditioner is selected, the setting screen G20 for performing the control of such air conditioner is displayed on the display 11. Specifically, an air conditioner-specific control setting such as a setting of a switching of run/stop/air cleaning (clean sky) or an operational state G21 such as a temperature, a setting of an operational mode G22 such as an automatic/cooling/heating/dehumidifying, and a setting of an air-volume switching G23 such as an automatic/breeze/moderate wind/strong wind is performed on the setting screen G20 (announcing through the ECHONET Lite to the appliance to be set).

In addition, the ON/OFF states of the ECO mode is set on the setting screen G20 by an operation button B21. An operation button B22 is an operation button for returning to a previous screen. Through this setting screen G20, the user can set the ON/OFF states of the ECO mode for each of the electric-appliance icons by the selection operation of the electric-appliance icons G41-1 to G41-8.

In addition, according to the above-described embodiment, the power information terminal 1 may set the ECO mode to the electric appliances 22-1 to 22-8 in accordance with a preset schedule setting to transmit ECO mode transition instruction when it is the schedule time. Moreover, in this case, the ECO mode icons may be displayed in a display form in which the ECO mode by the schedule setting is distinguished from the ECO mode by the individual operation of the user. Further, it is possible to display the ECO mode icons by distinguishing the ECO mode by the individual setting of the user, the ECO mode by the DR setting, and the ECO mode by the schedule setting from one another.

Further, the power information terminal 1 of the present embodiment may be embedded in the indoor wall surface of building structures such as homes or office buildings in which various electric appliances are provided. As an embedded location in this case, for example, an entrance lobby or the wall surface of a living room can be considered. In addition, the power information terminal 1 may be incorporated in the electric appliances such as a refrigerator.

Furthermore, a program executed by the power information terminal 1 of the present embodiment is provided as being programmed previously in the ROM or the like. The program executed by the power information terminal 1 of the present embodiment may be configured so as to be recorded and provided in the form of an installable or executable file on a computer-readable recording medium such as a CD-ROM, a flexible disk (FD), a CD-R, or a DVD (Digital Versatile Disk).

Furthermore, the program executed by the power information terminal 1 of the present embodiment may be configured so as to be stored on a computer connected to a network such as the Internet and to be provided through the network by downloading. In addition, the program executed by the power information terminal 1 of the present embodiment may be configured so as to be provided or distributed through the network such as the Internet.

The program executed by the power information terminal 1 of the present embodiment has a module configuration including the above-described functional configurations, and as a practical hardware, a CPU (processor) reads out the program from the ROM described above and executes it such that the above-described functional configurations are loaded and generated on a main memory device.

Moreover, the various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A display device comprising:
a setting module configured to set a first ECO mode and a second ECO mode different from the first ECO mode to an electric appliance which is a managed object of HEMS (Home Energy Management System), each of the first and second ECO modes being for reducing an amount of power consumption; and
a display configured to display an icon corresponding to the electric appliance differently between the set first ECO mode and the set second ECO mode.

2. The display device of claim 1, wherein the display is configured to display a first icon indicating the first ECO mode and corresponding to the electric appliance to which the first ECO mode is set, and display a second icon indicating the second ECO mode and corresponding to the electric appliance to which the second ECO mode is set, on a position different from a position where the first icon is displayed.

3. The display device of claim 1, further comprising:
an acquisition module configured to acquire an amount of power consumption in the electric appliance of the managed object,
wherein the display is further configured to display the acquired amount of power consumption.

4. The display device of claim 3, wherein the display is further configured to display a limit value for limiting the amount of power consumption based on the set first ECO mode or the set second ECO mode.

5. The display device of claim 4, wherein the display is configured to display a graph obtained by adding the limit value to the acquired amount of power consumption.

6. The display device of claim 5, wherein when two ECO modes of the first and second ECO modes are set, the display displays the graph in which a larger control value of two control values based on the two ECO modes is an upper value.

7. The display device of claim 3, wherein the acquisition module is configured to acquire an amount of power consumption for each of a plurality of the electric appliances of the managed object, and
wherein the display is configured to display the acquired amount of power consumption for each of the electric appliances.

8. The display device of claim 1, further comprising:
an operation module configured to receive an operation of a user,
wherein one of the first and second ECO modes is set based on the operation of the user.

9. The display device of claim 8, wherein the display is configured to display the set first ECO mode and the set second ECO mode differently between the set first ECO mode and the set second ECO mode and display a screen configured to receive a selection operation of each of the electric appliances of the managed object, and
wherein the operation module is configured to receive a setting of an ECO mode on the electric appliances selected by the selection operation of the screen.

10. The display device of claim 1, further comprising:
a communication module configured to communicate with an external device,
wherein one of the first and second ECO modes is set based on a communication with the external device.

11. The display device of claim 1, further comprising:
a transmitter configured to transmit a first ECO mode transition instruction corresponding to the first ECO mode and a second ECO mode transition instruction corresponding to the second ECO mode to the electric appliance,
wherein the first ECO mode transition instruction and the second ECO mode transition instruction is configured to instruct the electric appliance to transit to a same power state, respectively.

12. A display method comprising:
setting a first ECO mode and a second ECO mode different from the first ECO mode to an electric appliance which is a managed object of HEMS (Home Energy Management System), each of the first and second ECO modes being for reducing an amount of power consumption; and
displaying an icon corresponding to the electric appliance differently between the set first ECO mode and the set second ECO mode.

13. A computer program product having a non-transitory computer readable medium including programmed instructions, wherein the instructions, when executed by a computer, cause the computer to perform:
setting a first ECO mode and a second ECO mode different from the first ECO mode to an electric appliance which is a managed object of HEMS (Home Energy Management System), each of the first and second ECO modes being for reducing an amount of power consumption; and
displaying an icon corresponding to the electric appliance differently between the set first ECO mode and the set second ECO mode.
